(19) United States
(12) Patent Application Publication
(10) Pub. No.: US 2014/0282841 A1
(43) Pub. Date: Sep. 18, 2014

(54) METHOD AND SYSTEM FOR MANAGING SERVICE REQUESTS IN A CONNECTED VEHICLE

(71) Applicant: HONDA MOTOR CO., LTD., Tokyo (JP)

(72) Inventor: Fuminobu Kurosawa, San Jose, CA (US)

(73) Assignee: Honda Motor Co., Ltd., Tokyo (JP)

(21) Appl. No.: 13/842,949

(22) Filed: Mar. 15, 2013

(51) Int. Cl. G06F 21/62

(52) U.S. Cl. CPC G06F 21/62
USPC 726/1

(57) ABSTRACT

A method and system for managing service requests to a vehicle connected to a portable device, including receiving at the portable device a service request from a requesting party and determining a connectivity status of the portable device. An access rule enabling processing of the request is obtained based on an identity of the requesting party and the connectivity status. The request and the access rule are redirected to a vehicle bus interface for processing the request, where the vehicle bus interface restricts access to vehicle data based on the access rule.

### BACKGROUND

Advancements in automotive electronics, wireless technologies and demands for mobile connectivity are enabling vehicle manufacturers to extend the driving experience of a vehicle beyond simply driving to a connected driving experience whereby the vehicle is a connected vehicle. The connected vehicle provides connectivity to other devices, infrastructures and vehicles, thereby enabling bi-directional communication and information exchange. As the connected vehicle extends beyond in-vehicle infotainment to external environments, design of the connected vehicle infrastructure and related applications requires management of access to the connected vehicle and vehicle data.

### SUMMARY

According to one aspect, a computer-implemented method for managing service requests to a vehicle connected to a portable device includes receiving at the portable device a service request from a requesting party, where the request is for vehicle data from the vehicle. The method further includes determining a connectivity status of the portable device and obtaining an access rule enabling processing of the request, where the access rule is based on at least one of an identity of the requesting party and the connectivity status. The request is redirected with the access rule to a vehicle bus interface for processing the request, where the vehicle bus interface restricts access to the vehicle data based on the access rule.

According to another aspect, a system for managing service requests to a connected vehicle includes a portable device for receiving a service request from a requesting party for vehicle data from the vehicle. The system further includes a service request processor for determining a connectivity status of the portable device and obtaining an access rule enabling processing of the request, where the access rule is based on at least one of an identity of the requesting party and the connectivity status. The service request processor is further for redirecting the request with the access rule to a vehicle head unit. The system further includes a vehicle bus interface located on the vehicle head unit for restricting access to the vehicle data based on the access rule.

According to still another aspect, a non-transitory machine-readable medium for providing executable instructions operable to manage requests for a vehicle connected to a portable device includes receiving a service request from a requesting party for vehicle data, determining a connectivity status of the portable device and obtaining an access rule enabling processing of the request, where the access rule is based on at least one of an identity of the requesting party and the connectivity status. The method further includes redirecting the request with the access rule to a vehicle bus interface for processing the request, where the vehicle bus interface restricts access to the vehicle data based on the access rule.

According to still yet another aspect, a computer-implemented method for managing service requests to a connected vehicle, includes receiving at the vehicle a service request for access to vehicle data from a requesting party and determining a connectivity status of a location associated with the requesting party. The method also includes obtaining an access rule enabling processing of the request, where the access rule is based on at least one of an identity of the requesting party and the connectivity status. The method further includes redirecting the request with the access rule to a vehicle bus interface for processing the request, where the vehicle bus interface provides the requesting party access to the vehicle data based on the access rule.

### BRIEF DESCRIPTION OF THE DRAWINGS

FIG. 1 is a schematic view of an operating environment according to an exemplary embodiment;

FIG. 2 is a system architecture of a portable device according to an exemplary embodiment;

FIG. 3 is a system architecture of an exemplary (e.g., Android) operating system;

FIG. 4 is a system architecture of a vehicle control system for managing service requests according to an exemplary embodiment;

FIG. 5 is a schematic view of a connected vehicle system according to according to an exemplary embodiment;

FIG. 6 is a process flow diagram of a method for managing services requests for vehicle data according to an exemplary embodiment;

FIG. 7 is a Unified Model Language (UML) class description for an exemplary application programming interface (API) according to an exemplary embodiment; and

FIG. 8 is a schematic view of a bus interface according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting.

A “bus”, as used herein, refers to an interconnected architecture that is operably connected to other computer components inside a computer or between computers. The bus can transfer data between the computer components. The bus can a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “machine-readable medium”, as used herein, refers to a medium that provides signals, instructions and/or data. A machine-readable medium can take forms, including, but not limited to, non-volatile media and volatile media. Non-volatile media can include, for example, optical or magnetic disks, and so on. Volatile media can include, for example, semiconductor memories, dynamic memory, and so on. Common forms of a machine-readable medium include, but are not limited to, a floppy disk, a flexible disk, a hard disk, a magnetic tape, other magnetic medium, other optical medium, a RAM (random access memory), a ROM (read only memory), and other media from which a computer, a processor or other electronic device can read.

A “disk”, as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

An “operable connection”, or a connection by which entities are “operably connected”, is one in which signals, physical communications, and/or logical communications can be sent and/or received. An operable connection can include a physical interface, a data interface and/or an electrical interface.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “portable device”, as used herein, is a computing device typically having a display screen with user input (e.g., touch, keyboard) and a processor for computing. Portable devices include, but are not limited to, handheld devices, mobile devices, smart phones, laptops, tablets and e-readers.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, personal watercraft, and aircraft. In some cases, a motor vehicle includes one or more engines.

### Connected Vehicle System Overview

Referring now to the drawings, wherein the showings are for purposes of illustrating one or more exemplary embodiments and not for purposes of limiting same, FIG. 1 is a system level overview of an exemplary environment 100 for a connected vehicle 102 capable of bi-directional computer communication with a portable device 104 and a network 106. One having ordinary skill in the art will appreciate that the components of environment 100, as well as the components of other systems and software architectures discussed herein, can be combined, omitted or organized into different architectures for various embodiments.

The vehicle 102 includes a vehicle computing system (VCS) 108 (e.g., a telematics unit, a head unit) with provisions for processing, communicating and interacting with various components of the vehicle 102 and other components of the environment 100. The VCS 108 is operably connected to a bus 110 for accessing vehicle data 112. The vehicle data 112 can include data from various systems (not shown) of the vehicle 102. In particular, the vehicle data 102 can include diagnostic and non-diagnostic vehicle data accessed by the VCS 108 through a the bus 110 using, for example, a Controller Area Network (CAN) or a Local Interconnect Network (LIN) protocol.

In the illustrated embodiment, the portable device 104 can be located in the vehicle 102, for example, in possession of a vehicle occupant, or can be located outside of the vehicle 102. Further, in the illustrated embodiment, the network 106 is, for example, a data network, the Internet, a wide area network or a local area network. The network 106 serves as a communication medium to various devices located remotely from the vehicle 102 and the portable device 104, for example, servers (e.g., web servers, remote servers, application servers, intermediary servers), client machines and other devices 114.

The vehicle 102, the portable device 104 and the network 106 are operably connected for computer communication via communication links 116, 118 and 120. Specifically, the vehicle 102 is operably connected to the portable device 104 via link 116. The link 116 can establish computer communication between the portable device 104 using wired or wireless communication. For example, wired communication can be provided using a Universal Serial Bus or other wired protocols known in the art. Wireless communication can be provided using near field communication (NFC), Bluetooth, WiFi, ZigBee, cellular communication (e.g., Code Division Multiple Access (CDMA), Global System for Mobile Communications (GSM), Long Term Evolution (LTE)) or other wireless protocols known in the art. The vehicle 102 is further operably connected to the network 106 via link 120. In another embodiment, the vehicle 102 is operably connected to the network 106 through the portable device 104 using links 116 and 120. The links 118 and 120 can also be established wirelessly using the protocols discussed above.

### Portable Device System Architecture

Referring now to FIG. 2, a system architecture of the portable device 104 according to an exemplary embodiment is illustrated. In FIG. 2, the portable device 104 includes an application layer 202, a middleware layer 204, an operating system (OS) layer 206 and a hardware layer 208. An exemplary OS layer 206 is further illustrated in FIG. 3 implemented as an Android OS. One having ordinary skill in the art will understand that components of FIGS. 2 and 3 can be combined, omitted or organized into different architectures. For example, the application layer 202 can also include components of the Android OS application layer in FIG. 3.

Referring again to FIG. 2, the application layer 202 includes native applications 210, non-native applications 212 (e.g., third party) and original equipment manufacturer (OEM) applications 214 which run on the portable device 104. The native applications 210 are locally installed and designed by the manufacturer of the portable device 104 to run on the portable device operating system (e.g., Android). For example, native applications 210 can include the applications contacts, phone and browser illustrated in FIG. 3. Non-native applications 212 include applications provided by third-parties. OEM applications 214 include specific applications provided by a vehicle OEM for interaction with the vehicle 102 and the portable device 104. The OEM applications 214 can be associated with a specific Graphic User Interface (GUI) for launching OEM applications 214 on the portable device 104 provided by an OEM server (e.g., a private server 516, FIG. 5).

The middleware layer 204 can include libraries, frameworks and application programming interfaces (API) for operating the portable device 102 and applications on the portable device 102. For example, the communication framework (Com FW) 216 includes provisions for connectivity and communication with external servers and device and application authentication. The vehicle framework (Car FW) 218 is a specific framework for communicating with the vehicle 102, handling vehicle data exchange and providing touch panel events between the portable device 104 and the VCS 108. The mirror link framework 220 (FW) manages media and audio between the portable device 104 and the VCS 108. For example, the mirror link framework 220 includes provisions for replicating a portable device interface on a human machine interface (HMI) of the VCS 108.

The operating system (OS) layer 206 generally provides services for managing hardware and software resources of the portable device 104 and includes an OS Core 222. The OS Core 222 can be, for example, Android (see FIG. 3), iOS, Mobile Linux, Symbian OS, Windows Mobile, BlackBerry OS, Web OS, or other operating systems known in the art. Further, the hardware layer 208 includes provisions for direct management and access of hardware resources. The portable device 208 can include hardware such as a memory 224, a storage 226, and input/output devices 228 as known in the art.

### VCS System Architecture

Referring now to FIG. 4, a system architecture of the VCS 108 according an exemplary embodiment is illustrated. The VCS 108 includes a human machine interface (HMI) HMI layer 402, an application layer 406, a middleware layer 408, an operating system layer (OS) layer 410 and a hardware layer 412. The HMI layer 402 includes provisions (i.e. graphical user interface (GUI) 414, speech 416 and HMI core 418) for interfacing with the VCS 108. Specifically, the components of the HMI layer 402 control an HMI 404 operably connected to the VCS 108 and processes all user inputs coming into the system such as touch screen input, speech recognition, among others. The application layer 406 includes applications native to the VCS 108, for example, a navigation application 420 and an audio application 422.

The middleware layer 408 includes libraries, frameworks and application programming interfaces (API) to realize the functions of the VCS 108 and of the application layer 406. For example, the vehicle framework (FW) 424 with vehicle FW 218 (FIG. 2, portable device 104) facilitates handling vehicle data, providing touch panel events and monitoring the vehicle 102 state. The media framework (FW) manages media and graphics of the VCS 108. The mirror link framework 428 (FW), with the mirror link framework 220, handles media and audio between the portable device 104 and the VCS 108. The communication framework 430 (Com FW) includes provisions for connectivity and communication with external servers and devices. The bus interface 432 (I/F) provides and manages access to vehicle data 112 via the bus 110.

The OS layer 410 includes an operating system core 434 (e.g., Windows) and device drivers 436 specific to the VCS 108. The hardware layer 412 includes provisions for management and access of hardware resources. Hardware resources can include a processor 438, a memory 440, a storage 442 and vehicle specific input/output devices 444. The hardware layer can also include the HMI 404 and the bus 110.

### Connected Vehicle System for Managing Service Requests

According to one embodiment illustrated in FIG. 5, a connected vehicle system 500 for managing services requests to a connected vehicle includes a portable device 504, a vehicle computing system (VCS) 508, a network 506, a bus 510 and vehicle data 512. The components of system 500 correspond to the components of FIGS. 1-3. For simplicity, the system 500 does not illustrate all of the components of FIGS. 1-3. However, the system 500 can include some or all of aforementioned components (e.g., software layers, communication links). Further, the corresponding components can perform some or all of the functionality discussed above.

In the illustrative embodiment of FIG. 5, the network 506 includes services 514. The services 514 can receive data from the portable device 504 and the VCS 508 for processing and storage. The services 514 can be application services, web services, cloud services, among others. The network 506 also includes a private server 516 and a public server 520, which can be application servers. The servers 516 and 520 include front end and back end components (not shown) for facilitating services 514. For example, a service 514 can be initiated (e.g., a service request) from the servers 516, 520 by a web interface, an application, a browser, among others. A service 514 could also be initiated automatically based on an event or action. The response or data received from a service request can be processed or stored by the private server 516 or the public server 520.

In one embodiment, the private server 522 is an original equipment manufacturer (OEM) server maintained by the OEM of the vehicle 102 for specific vehicle data handling and functions related to the VCS 108. For example, the OEM server can include storage of user data and vehicle data, device authentication managers, application managers, among others.

In the illustrated embodiment of FIG. 5, the portable device 504 includes an application layer 522 and a middleware layer 524. The application layer 522 includes native applications 526, non-native applications 528 and OEM applications 530. The middleware layer 524 includes a communication framework (com FW) 532 and a vehicle framework (FW) 534. The VCS 508 includes an application layer 536 and a middleware layer 538. The application layer 536 includes applications native to the VCS 508, for example, a navigation application 540 and an audio application 542. The middleware layer includes a communication framework 544 (Com FW), a vehicle framework 546 (FW) and a bus interface 548 (I/F). The portable device 504 and the VCS 508 are operably connected for computer communication through communication link 550, which may be similar to communication link 116 of FIG. 1.

With reference to FIG. 6, a computer implemented method is shown for managing service requests to a vehicle connected to a portable device. In another embodiment, service requests are managed directly at the VCS without regard to the portable device. The method of FIG. 6 will now be described in association with the computer system 500 and FIGS. 1-5, though it is to be appreciated that the method could be used with other computer systems.

Throughout the detailed description, it is to be appreciated that service requests can originate from different entities and structures. In one example, the service request originates from the network 506 (i.e., services 514). The service request could be directly transmitted to the portable device 504 via the communication framework 534 or directly to the VCS 508 via the communication framework 544. Alternatively, an application at the application layer 522 or the application layer 536 can be an intermediary for the service request to the communication framework 532 or the communication framework 544 respectively. Transmission of the service request can occur over transfer protocols known in the art, for example, Hypertext Transfer Protocol (HTTP), Hypertext Transfer Protocol Secure (HTTPS), Short Message Service (SMS), File Transfer Protocol (FTP), among others. Those having ordinary skill in the art will contemplate these scenarios and transmission protocols with respect to the methods and systems described herein.

Continuing reference to FIG. 6, at step 602, the method includes receiving at the portable device a service request from a requesting party. For example, the portable device 504 can receive via the communication framework 532 a service request 552 from the network 506 (i.e., services 514). The service request 552 can originate from a requesting party. For example, a requesting party can be a private server 516 (i.e., a private party) or a public server 520 (i.e., a public party). In another embodiment, the service request can originate from an application at the portable device 504, for example, a native application 526, a non-native application 528 or an OEM application 530. The request can be for vehicle data 512 accessed via the bus interface 548. The dotted line from the services 514 to the vehicle data 512 illustrates an exemplary path of the service request 552.

In another embodiment, the method includes receiving at the vehicle a service request for access to vehicle data from a requesting party. For example, the network 506 could transmit the request directly to the VCS 508 (i.e., via the communication framework 544). Alternatively, an application at the VCS 508 (i.e., the navigation application 540, the audio application 542), could request a service for vehicle data 512.

In a further embodiment, the service request can be structured as an application programming interface (API) service call. An API can be provided and defined by the vehicle framework 534, the vehicle framework 546 or the bus interface 548. FIG. 7 illustrates a Uniform Modeling Language (UML) class diagram of an exemplary API. In particular, FIG. 7 illustrates two exemplary resource families 702, 704 and data transfer objects 706 (DTO) associated with the families 702, 704. The API of FIG. 7 is a REST (Representational State Transfer) API, however, it is appreciated that any suitable programmatic communication interface can be used, for example, a SOAP (Simple Object Access Protocol) API. The REST API is URL based utilizing HTTP or HTTPS to communicate with other devices.

Referring back to FIG. 6, at step 604, the method further includes, determining a connectivity status of the portable device. The connectivity status indicates whether the portable device is operably connected for computer communication to an active network (e.g., the Internet, a wide area network, a land area network, a cellular network). For example, the connectivity status can indicate whether the portable device 504 is operably connected to a network 506. In another embodiment, the connectivity status indicates whether a wireless connection from the portable device to an active network is enabled. In another embodiment, the connectivity status indicates whether the VCS 508 is operably connected for computer communication to an active network. A connectivity statuses can be indicated by an ONLINE or OFFLINE status.

The vehicle framework 534 or the vehicle framework 546 can include provisions for determining the connectivity status of the portable device 504. In one embodiment, a service request processor including a connectivity manager (not shown) provided by the portable device at the middleware layer 524 facilitates determining the connectivity status. For example, the Android OS provides a ConnectivityManager object (See FIG. 3) that includes a getActiveNetworkInfo( ) method (not shown). This method returns a NetworkInfo instance representing connectivity information about the portable device. If none of the portable device interfaces are connected, a null variable is returned to the method. Thus, if a null variable is returned, the connectivity status can be set to OFFLINE, otherwise, the connectivity status is set to ONLINE.

It is appreciated that the connectivity status of the portable device 504 can also be determined based on monitoring events (e.g., routines, functions) and associated communication requests and responses handled by the portable device 504. Exemplary events can include, but are not limited to, touch panel events, CAN events, audio events, video events or other events associated with other applications (e.g., native applications 210, non-native applications 212, or OEM applications 214). If a response is not received for a request associated with an event, the portable device 504 (e.g., with functionality provided by the middleware layer) can determine that the connectivity status is OFFLINE. If a response is received, the portable device 504 can determine that the connectivity status is ONLINE. Therefore, by monitoring events and associated communication requests and responses, the connectivity status of the portable device 504 can be determined. It is appreciated that requests and responses can use various types of communication and protocols, as known in the art. Exemplary types of communication and protocols include, but are not limited to, Remote Procedure Cell (RPC), video compression standards (H264, AAC) over Transmission Control Protocol/Internet Protocol (TCP/IP). It is appreciated that the aforementioned events and associated communicated requests and responses can also be used with respect to determined whether the VCS 508 is connected to an active network.

Referring again to FIG. 6, if the connectivity status is ONLINE, the method can optionally include at step 608 determining a connectivity type. A connectivity type could be related to the protocol used for wireless communication. For example, the portable device 506 or the VCS 508 could be connected to the network 506 via a cellular network, but not a WiFi network, and vice versa.

In a further embodiment, a connectivity status of a location associated with the requesting party is determined. The location can be a device from which the service request originates from and the connectivity status can indicate whether the device is accessible over a vehicle network. For example, the connectivity status of the server 516 or 520 from which a service 514 originates from can indicate whether the server 516 or 520 is accessible to the portable device 504 of the VCS 508 via the connected vehicle network 500. The connectivity status can be determined with provisions from the vehicle framework 534 or the vehicle framework 546 as discussed above.

Referring back to FIG. 6, the method optionally includes determining an identity of the requesting party at step 608. The identity can be defined as a public party or as a private party. Generally, a public party is a device or entity available to the general public. A private party, is a device or entity with a trusted relationship to the portable device 504 or the VCS 508. In one example, the private party is a private server 516 (i.e., an OEM server), an OEM application 530 or an application native to the VCS 508 (i.e. navigation application 540, audio application 542). The private party can also be an OEM application 530 located or stored on the portable device 504 or on an external network (i.e., at servers 516, 520 at the network 506).

At step 612, the method includes obtaining an access rule enabling processing of the request, wherein the access rule is based on at least one of an identity of the requesting party and the connectivity status. The access rule can be defined by the requesting party. For example, the OEM server (i.e., the private server 516) can include a database from which the portable device 504 or the VCS 508 can obtain an access rule associated with the identity of the requesting party and the connectivity status. In another example, a permissions table can be located on the OEM server allowing the portable device 504 or the VCS 508 to look-up an access rule.

In one example, if the identity of the requesting party is private, the access rule can define a private access rule to the vehicle data 512. If the requesting party is public, the access rule can define a public access rule to the vehicle data 512. In another example, if the connectivity status is OFFLINE, the access rule can define a private access rule to the vehicle data 512. If the connectivity status is ONLINE, the access rule can define a public access rule to the vehicle data 512.

At step 614, the method includes redirecting the request with the access rule to a vehicle bus interface for processing the request, where the vehicle bus interface restricts access to the vehicle data based on the access rule. For example, the vehicle framework 534 or the vehicle framework 546 can redirect a service request with an access rule to the bus I/F 548. If the access rule is a public access rule, the bus I/F 548 can limits access to diagnostic data of vehicle data 512 only. If the access rule is a private access rule, the vehicle bus interface can allow access to diagnostic and non-diagnostic data of the vehicle data 512.

FIG. 8 illustrates a detailed schematic view of the bus I/F 548 located at the VCS 508. A request 502 is redirected to the bus I/F 548 via the vehicle framework 534 or the vehicle framework 548. The bus I/F 548 determines whether the request 602 can receive private data access 604 or public data access 608 based on the access rule. Alternatively, the bus I/F 548 can call a function getData( ) 610 to retrieve and return the requested vehicle data to the requesting party from vehicle data 512 via bus 510 based on the private data access 604 or the public data access 608. If the requesting party is a public party, the bus interface returns diagnostic vehicle data only. If the wireless connection (i.e., connectivity status) is enabled, the bus I/F 548 can restrict access to the vehicle data based on the connectivity type.

In one exemplary embodiment, the getData( ) function is a service request from an API defined in FIG. 7. It is appreciated that the Get Data resource 702 and 704 can include various functions with various parameters and the functions and parameters in FIG. 7 are exemplary in nature. The getData( ) resource 702 can include the following parameters: key, connectStatus and dataVar. The key can be an API key distributed with the API. The identity of the requesting party, for example, as discussed with step 608 of FIG. 6, can be determined based on the key. The connectStatus parameter indicates a connectivity status as described with step 604 of FIG. 6. The dataVar is an object containing a specific request for specific types of vehicle data. For example, dataVar may include a parameter VEHICLE_SPEED, indicating to retrieve the current vehicle speed from vehicle data 512. Based on the API call using getData( ) of resource 702, the bus interface I/F 548 can determine or obtain an access rule using the key and the connectStatus parameters and return a data transfer object in response to the requesting party. Alternatively, provisions found in the vehicle framework 534 or the vehicle framework 546 can determine or obtain the access rule and submit the API call with the access rule as illustrated by the getData( ) resource 704.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for managing service requests to a vehicle connected to a portable device, comprising:
receiving at the portable device a service request from a requesting party, wherein the request is for vehicle data from the vehicle;
determining a connectivity status of the portable device;
obtaining an access rule enabling processing of the request, wherein the access rule is based on at least one of an identity of the requesting party and the connectivity status; and
redirecting the request with the access rule to a vehicle bus interface for processing the request, wherein the vehicle bus interface restricts access to the vehicle data based on the access rule.

2. The computer-implemented method of claim 1, further including determining the identity of the requesting party as a public party or a private party.

3. The computer-implemented method of claim 2, wherein the private party is an Original Equipment Manufacturer (OEM) application located on the portable device

4. The computer-implemented method of claim 2, wherein the private party is an Original Equipment Manufacturer (OEM) server located on an external network communicatively coupled to the portable device.

5. The computer-implemented method of claim 2, wherein if the requesting party is a public party, the vehicle bus interface limits access to diagnostic vehicle data.

6. The computer-implemented method of claim 1, wherein the connectivity status indicates whether the portable device is communicatively coupled to an active network.

7. The computer-implemented method of claim 6, wherein if the connectivity status is ONLINE, the vehicle bus interface limits access to diagnostic vehicle data.

8. The computer-implemented method of claim 6, wherein if the portable device is communicatively coupled to the active network, the method further includes determining a connectivity type.

9. The computer-implemented method of claim 8, wherein the vehicle bus interface restricts access to the vehicle data based on the connectivity type.

10. A system for managing service requests to a connected vehicle, comprising:
a portable device for receiving a service request from a requesting party for vehicle data from the vehicle;
a service request processor for determining a connectivity status of the portable device, obtaining an access rule enabling processing of the request, wherein the access rule is based on at least one of an identity of the requesting party and the connectivity status, and redirecting the request with the access rule to a vehicle head unit; and
a vehicle bus interface located on the vehicle head unit for restricting access to the vehicle data based on the access rule.

11. The computer-implemented method of claim 10, wherein the service request processor further determines the identity of the requesting party as a public party or a private party.

12. The computer-implemented method of claim 11, wherein the private party is an Original Equipment Manufacturer (OEM) application stored on the portable device.

13. The computer-implemented method of claim 11, wherein the private party is an Original Equipment Manufacturer (OEM) server located on an active network communicatively coupled to the portable device.

14. The computer-implemented method of claim 11, wherein if the requesting party is a public party, the vehicle bus interface returns diagnostic vehicle data only.

15. The computer-implemented method of claim 10, wherein the connectivity status indicates whether a wireless connection from the portable device to an active network is enabled.

16. The computer-implemented method of claim 15, wherein if the connectivity status is enabled, the vehicle bus interface returns diagnostic vehicle data only.

17. The computer-implemented method of claim 15, wherein if the wireless connection is enabled, the method further includes determining a connectivity type.

18. The computer-implemented method of claim 17, wherein the vehicle bus interface restricts access to the vehicle data based on the connectivity type.

19. A non-transitory machine-readable medium for providing executable instructions operable to manage requests for a vehicle connected to a portable device, the method comprising:
receiving a service request from a requesting party for vehicle data;
determining a connectivity status of the portable device,
obtaining an access rule enabling processing of the request, wherein the access rule is based on at least one of an identity of the requesting party and the connectivity status; and
redirecting the request with the access rule to a vehicle bus interface for processing the request, wherein the vehicle bus interface restricts access to the vehicle data based on the access rule.

20. The non-transitory machine-readable medium of claim 19, wherein the connectivity status indicates whether a wireless connection from the portable device to an active network is enabled.

21. The non-transitory machine-readable medium of claim 19, further including determining the identity of the requesting party as a public party or a private party, wherein a private party is an Original Equipment Manufacturer (OEM) application stored on the portable device.

22. A computer-implemented method for managing service requests to a connected vehicle, comprising:
receiving at the vehicle a service request for access to vehicle data from a requesting party;
determining a connectivity status of a location associated with the requesting party;
obtaining an access rule enabling processing of the request, wherein the access rule is based on at least one of an identity of the requesting party and the connectivity status; and
redirecting the request with the access rule to a vehicle bus interface for processing the request, wherein the vehicle bus interface provides the requesting party access to the vehicle data based on the access rule.

23. The computer-implemented method of claim 22, wherein the location is a device from which the service request originates from and the device is accessible over a vehicle network.

24. The computer-implemented method of claim 23, wherein the connectivity status indicates whether the device is communicatively coupled to an active network.

25. The computer-implemented method of claim 22, further including determining the identity of the requesting party as a public party or a private party.

26. The computer-implemented method of claim 25, wherein if the requesting party is a public party, the vehicle bus interface the vehicle bus interface limits the requesting party access vehicle data.
